(19) United States
(12) Patent Application Publication
(10) Pub. No.: US 2003/0101363 A1
(43) Pub. Date: May 29, 2003

(54) Method and system for minimizing power consumption in embedded systems with clock enable control

(76) Inventor: Paul L. Master, Sunnyvale, CA (US)

Correspondence Address: Joseph A. Sawyer, Jr., SAWYER LAW GROUP LLP, P.O. Box 51418, Palo Alto, CA, 94303, US

(21) Appl. No.: 09/996,094

(22) Filed: Nov. 27, 2001

(51) Int. Cl. G06F 1/26

(52) U.S. Cl. 713/324

(57) ABSTRACT

Aspects of reducing power consumption in an embedded system with clock enable control are provided. These aspects include performing desired processing in the embedded system via an adaptive computing engine (ACE). Further included is controlling clock enabling on each individual element configured for the ACE to minimize a number of elements requiring power at any give time in the embedded system. A data stream is utilized to configure the ACE to perform the desired processing and data for the clock enabling is embedded within the data stream.

### FIELD OF THE INVENTION

The present invention relates to minimizing power consumption in embedded systems with clock enable control.

### BACKGROUND OF THE INVENTION

The electronics industry has become increasingly driven to meet the demands of high-volume consumer applications, which comprise a majority of the embedded systems market. Examples of consumer applications where embedded systems are employed include handheld devices, such as cell phones, personal digital assistants (PDAs), global positioning system (GPS) receivers, digital cameras, etc. By their nature, these devices are required to be small, low-power, light-weight, and feature-rich. Embedded systems face challenges in producing performance with minimal delay, minimal power consumption, and at minimal cost. As the numbers and types of consumer applications where embedded systems are employed increases, these challenges become even more pressing.

In digital circuits, it is often advantageous to disable any circuitry that is not currently being used so that power is not dissipated unnecessarily. This is especially true in CMOS devices for which the bulk of power dissipation is due to switching currents. It is common to employ registers for capturing data in programmable devices. These registers operate, i.e., dissipate power, in response to clock signals. Thus, it has been recognized that suspending a clock signal which is supplied to such a register (e.g., when the output of the register need not change state) would result in a power savings because the register would not operate while the clock signal remains “off”. In addition, stopping the clock to large silicon structures, e.g., multipliers, ALUs, etc., would reduce power correspondingly.

Despite the recognition of the power savings which might be achieved by suspending a clock signal to a register or registers in a programmable device, some digital circuit designers have been reluctant to attempt such a solution. These designers recognize that unless the gating of the clock signal can be accomplished in a reliable, predictable fashion, such action may result in partial clock pulses being passed to a register. This may cause spurious clocking of the register when no clocking is needed or, perhaps worse, when invalid data is present at the input to the register. Such situations can lead to unrecoverable system malfunctions. Further, the cost and complexity of the hardware circuitry or software mechanism needed to control the clock enabling often present more challenges that outweigh the potential power savings benefit. For example, the number of registers (from one bit to many bits) may comprise a significant fraction of modem day designs, e.g., anywhere from 10% to 50%.

U.S. Pat. No. 5,912,572 provides a discussion of the prior art approaches to clock signalling in programmable logic devices. As discussed therein, programmable logic devices (PLDs) are popular general purpose logic devices. PLDs generally include an AND array, an OR array and an input/output (I/O) macrocell. A routing interconnect is used to transport signals to various elements within the device. The AND array typically includes a plurality of logical AND gates and generates a large number of output signals called AND (or product) terms. The AND terms are received by the OR array which generally includes a plurality of OR gates. The OR array generates a number of output signals, called sum terms, by ORing selected AND terms together. The sum terms generated by the OR array are then received by the I/O macrocell which comprises a number of circuit elements including D-type data registers. The I/O macrocell of most PLDs outputs signals from the PLD and also feeds output signals back into the AND array for further use.

Many families of programmable logic devices such as PLDs, complex PLDs (so-called CPLDs), field programmable gate arrays (FPGAs) and application specific integrated circuits (ASICs) are synchronously clocked devices. That is, these families of devices have dedicated pins which receive a system clock signal for use within the programmable logic device. For example, some conventional synchronous programmable logic devices receive clock input signals from dedicated clock/input pins and route such signals to programmable registers within one or more I/O macrocells.

Other families of PLDs can accommodate asynchronous clocking wherein the clock signals which are used to capture data in registers contained in these devices are created by logically combining a number of logic inputs and/or internally generated logic signals to create the clock signal. In these devices, a particular signal generated, for example, by the AND or OR array can be utilized, in place of a dedicated system clock, to capture a signal in one of the register elements in an I/O macrocell. This function is termed asynchronous clocking because a signal, other than a dedicated system clock/global clock, is utilized by one or more register elements.

Where the asynchronous clock signal is generated by the AND array, the asynchronous clock signal may be referred to as a product term clock signal. Where the asynchronous clock signal is generated by the OR array, it may be referred to as a sum term or a sum of products term if the asynchronous clock signal is generated by a combination of signals provided by the AND and OR arrays.

In architectures where an asynchronous signal is used by one or more register elements in an I/O macrocell as a clock signal, these logically derived clocks signals are restricted to very low frequencies of operation because the asynchronous signals usually must traverse the large general purpose logic array of the CPLD or FPGA. As a result, an input change in the incoming signal(s) from which the logic derived clock signal is created must wait for any proceeding transitions to transit the slow logic array signal path before the subsequent input transition can be processed. This restriction limits the frequency at which these devices can operate to frequencies much lower than those possible for synchronous operation in which external clock signals are applied directly to a register clock input via fast, dedicated clock signal paths.

In addition, the input signals from which the logic derived clock signal is created can arrive at unpredictable times at the programmable device. The unpredictable signal arrival time may result in a violation in the setup or hold time relative to the data signal to be captured in the register. The difference between logic derived clock signal and data signal transit times through the programmable device can be considerable. Therefore, to ensure that this potential mismatch in signal timing does not cause a violation of the data signal setup time or hold time relative to the logic derived clock signal input to the register, operation must be derated to allow for the worst case difference or skew between the data signal and the logic derived clock signals which can be anticipated in a given CPLD or FPGA due to variations in internal logic placement and routing.

FIG. 1 shows an example of product terms used to create logic derived clock signals in macrocells of a CPLD which are part of a larger logic array of one of the logic blocks of a CPLD. CPLD 10 includes macrocells 12 and logic block logic array 14. Logic block logic array 14 receives a number of signals 16 from a programmable interconnect matrix (PIM) within CPLD 10. The PIM (not shown) acts as a user programmable routing matrix for signals within the device. Signals 16 from the PIM are passed to logic block logic array 14 for routing to one or more macrocells 12. Note that, in general, signals 16 from the PIM include the logic complement of each signal. Thus, for “n” signals, 2n signal lines are present in logic block logic array 14. Likewise, each of the logic gates 18 in logic block logic array will have 2n input lines. For clarity, however, only one input line for each logic gate 18 is shown and this shorthand form of notation is typically employed and understood by those skilled in the art.

One or more of the signals 16 provided to logic block logic array 14 may be combined using dedicated logic gates 19 to produce a product term clock signal 20. Product term clock signal 20 may be used as a logic derived clock signal by a register 22 within one of the macrocells 12. In general, register 22 captures data signals presented on line 29 in response to a rising edge (or falling edge) of a clock signal (CLK) on clock line 25. Using a multiplexer 24 within macrocell 12, a user can select between product term clock signal 20 or a synchronous clock signal 26 as the means by which data signals can be captured in register 22. Data signals which are captured in register 22 may ultimately be provided to an output pad 28 and/or routed back through logic block logic array 14 or the PIM to form more complex signal combinations.

The product term clock signal 20 shown in FIG. 1 may be responsive to one or more external input signals which can arrive at CPLD 10 at any time from an external system. There is significant risk that these external signals will produce changes at the clock signal input of register 22 which will violate required setup and hold times relative to the data signal supplied on line 29 for capture by register 22. Such an occurrence can cause the wrong data state to be captured by register 22. Also, when setup and hold times are violated there is significant probability that a metastable event can occur which will cause an undesired logic state to be output by register 22 until the metastable event has been resolved. Even though the correct output logic state may eventually be obtained, the time required for recovery from the metastable condition can be much longer than the usual clock input to valid data output delay. Normally, additional margins must be added to the logic derived clock signal period to allow for the resolution of such metastable states. This requirement adds even more delay to the logic derived clock period, lowering the frequency of operation even further.

Also as shown in FIG. 1, if a “sum” expression is required to generate the product term clock signal 20, it must be created in another macrocell 12 and fed back to the input of the clock product term 19. This added pass through logic block logic array 14 reduces even further the possible frequency of operation of the product term clock signal 20.

It should be noted that the transit times for data signals and clock signals are strongly affected by the relative internal locations of the signal sources since FPGAs typically exhibit a wide distribution of internal interconnect delays. Consequently, the relative signal timing of the logic derived clock signal and the data signal is difficult to predict and designs which rely on logic derived clock signals cannot be guaranteed to function reliably. As a result of this timing unpredictability, some FPGAs provide a clock enable which can be used to wait for all the transit delays to occur before enabling the clock signal path to the logic cell register. This approach still requires a delay to be observed to accommodate the worst case possible delay in the clock signal path and the data signal must be held at the data input of the register to allow for this worst case delayed clock enable. This scheme results in very slow performance with logic derived clock signals.

A further scheme in normal ASIC/processor design is to add clock control on a large functional block level. For example, an entire sub-system, such as a MAC (multiply-accumulate) unit, is clock enabled even though power savings could be gained if sub-pieces of the design were controlled, e.g., just the multiplier or just the adder. Clock enabling an entire sub-system is normally done because the clock control hardware needed to predict what sub-pieces will be used becomes very complicated relative to the potential gain. That is, the prediction logic consumes significant area and any potential power savings. However, an approach that would allow more individualized clock enable control for design elements without complexity and concomitant cost of current approaches remains desirable.

Accordingly, what is needed is reliable and predictable clock enable control in an embedded system for minimizing power consumption. The present invention addresses such a need.

### SUMMARY OF THE INVENTION

Aspects of reducing power consumption in an embedded system with clock enable control are provided. These aspects include performing desired processing in the embedded system via an adaptive computing engine (ACE). Further included is controlling clock enabling on each individual element configured for the ACE to minimize a number of elements requiring power at any give time in the embedded system. A data stream is utilized to configure the ACE to perform the desired processing and data for the clock enabling is embedded within the data stream.

With the embedding of the clock enable information as a portion in the data stream, the present invention achieves absolute clock enable control on every clocked element individually, enabling the element for the absolute minimum of time, without requiring a prohibitively expensive control structure and without complicated algorithms to predict which elements to turn on or off. These and other advantages will become readily apparent from the following detailed description and accompanying drawings.

### BRIEF DESCRIPTION OF THE DRAWINGS

FIG. 1 illustrates the use of product term or asynchronous logic derived clock signals in macrocells of a conventional programmable device.

FIG. 2 is a block diagram illustrating an adaptive computing engine.

FIG. 3 is a block diagram illustrating, in greater detail, a reconfigurable matrix of the adaptive computing engine.

FIG. 4 is a diagram illustrating a data stream for the adaptive computing engine including clock enable control information in accordance with the present invention.

FIG. 5 is a diagram illustrating an example for the data stream of FIG. 4.

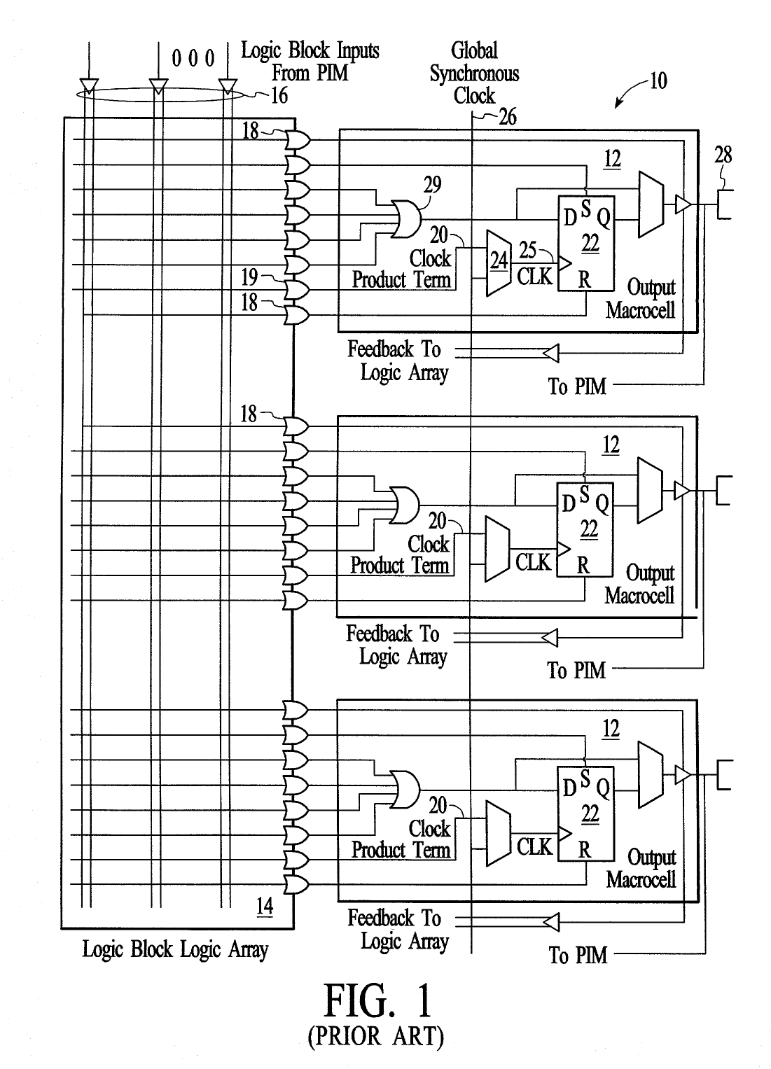

### DETAILED DESCRIPTION OF THE INVENTION

The present invention relates to minimizing power consumption in embedded systems with clock enable control.

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In a preferred embodiment, the processing core of an embedded system is achieved through an adaptive computing engine (ACE). A more detailed discussion of the aspects of an ACE are provided in co-pending U.S. patent application, Ser. No. ______, entitled ADAPTIVE INTEGRATED CIRCUITRY WITH HETEROGENEOUS AND RECONFIGURABLE MATRICES OF DIVERSE AND ADAPTIVE COMPUTATIONAL UNITS HAVING FIXED, APPLICATION SPECIFIC COMPUTATIONAL ELEMENTS, filed ______, assigned to the assignee of the present invention, and incorporated herein in its entirety. Generally, the ACE provides a significant departure from the prior art for achieving processing in an embedded system, in that data, control and configuration information are transmitted between and among its elements, utilizing an interconnection network, which may be configured and reconfigured, in real-time, to provide any given connection between and among the elements. While providing a shift in the approach to achieving operability, a concern for minimizing power consumption through efficient and reliable clock enable control remains and is addressed in the present invention, as described hereinbelow. In order to more fully illustrate the aspects of the present invention, portions of the discussion of the ACE from the application incorporated by reference are included in the following.

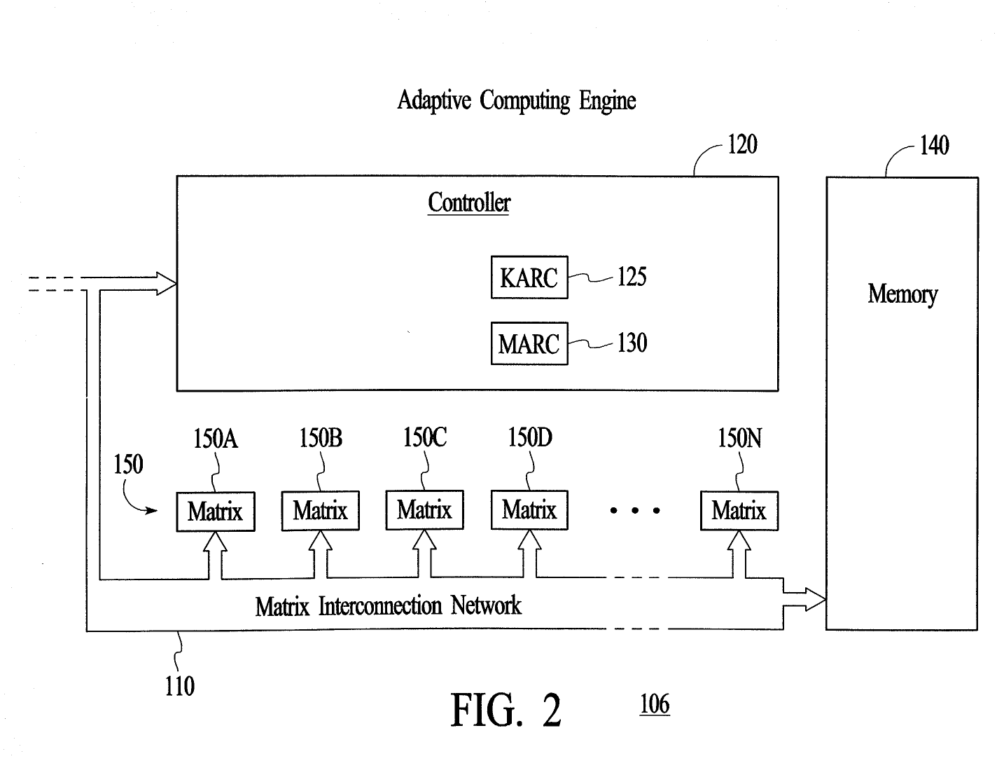

FIG. 2 is a block diagram illustrating an adaptive computing engine (“ACE”) 106 that includes a controller 120, one or more reconfigurable matrices 150, such as matrices 150A through 150N as illustrated, a matrix interconnection network 110, and preferably also includes a memory 140.

Fi re 3 is a block dia ram ill stratin, in reater detail, a reconfi rable matrix 150 with a pl rality of comp tation nits 200 (ill strated as comp tation nits 200A thro h 200N), and a pl rality of comp tational elements 250 (ill strated as comp tational elements 250A thro h 250Z), and provides additional ill stration of the preferred types of comp tational elements 250 and a sef l s mmary of aspects of the present invention. As ill strated in Fi re 3, any matrix 150 enerally inci des a matrix controller 230, a pl rality of comp tation (or comp tational) nits 200, and as lo ical or concept al s bsets or portions of the matrix interconnect network 110, a data interconnect network 240 and a Boolean interconnect network 210. The Boolean interconnect network 210 provides the reconfi rable interconnection capability between and amon the vario s comp tation nits 200, while the data interconnect network 240 provides the reconfi rable interconnection capability for data inp t and o tp t between and amon the vario s comp tation nits 200. It sho Id be noted, however, that while concept ally divided into reconfi ration and data capabilities, any iven physical portion of the matrix interconnection network 110, at any iven time, may be operatin as either the Boolean interconnect network 210, the data interconnect network 240, the lowest level interconnect 220 (between and amon the vario s comp tational elements 250), or other inp t, o tp t, or connection f nctionality.

Contin in to refer to Fi re 3, incl ded within a comp tation nit 200 are a pl rality of comp tational elements 250, ill strated as comp tational elements 250A thro h 250Z (collectively referred to as comp tational elements 250), and additional interconnect 220. The interconnect 220 provides the reconfi rable interconnection capability and input/output paths between and among the various computational elements 250. Each of the various computational elements 250 consist of dedicated, application specific hardware designed to perform a given task or range of tasks, resulting in a plurality of different, fixed computational elements 250. Utilizing the interconnect 220, the fixed computational elements 250 may be reconfigurably connected together to execute an algorithm or other function, at any given time.

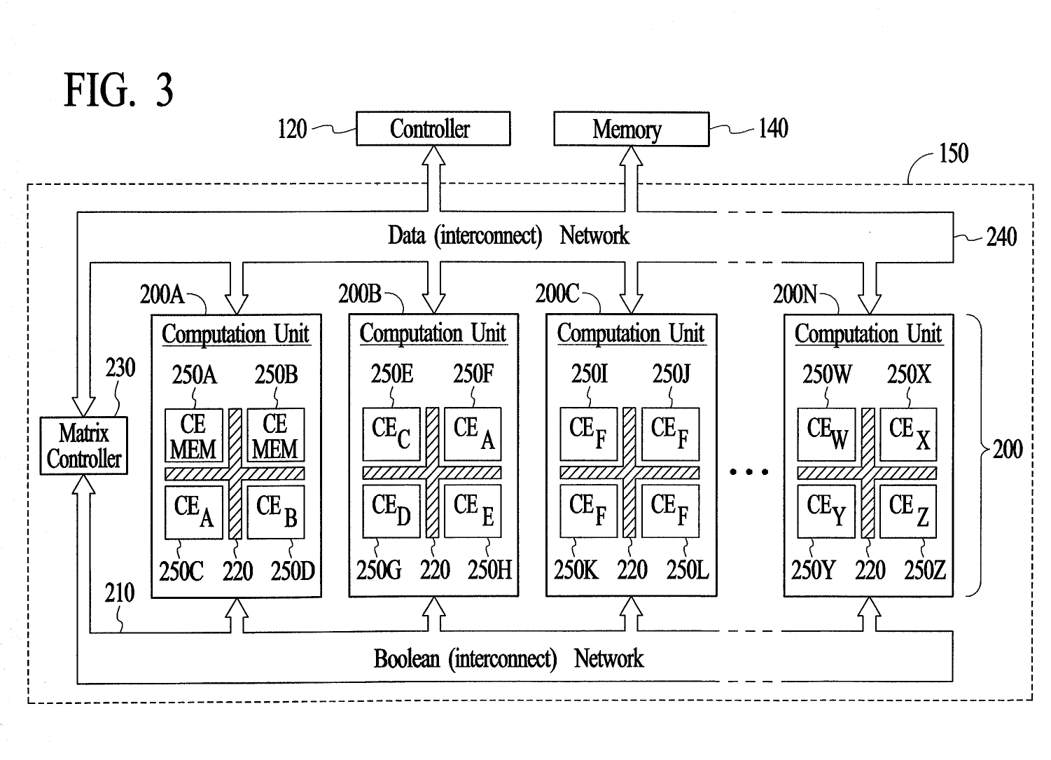

In a preferred embodiment, the various computational elements 250 are designed and grouped together, into the various reconfigurable computation units 200. In addition to computational elements 250 which are designed to execute a particular algorithm or function, such as multiplication, other types of computational elements 250 are also utilized in the preferred embodiment. As illustrated in FIG. 3, computational elements 250A and 250B implement memory, to provide local memory elements for any given calculation or processing function (compared to the more “remote” memory 140). In addition, computational elements 250I, 250J, 250K and 250L are configured (using, for example, a plurality of flip-flops) to implement finite state machines, to provide local processing capability, especially suitable for complicated control processing.

With the various types of different computational elements 250 which may be available, depending upon the desired functionality of the ACE 106, the computation units 200 may be loosely categorized. A first category of computation units 200 includes computational elements 250 performing linear operations, such as multiplication, addition, finite impulse response filtering, and so on. A second category of computation units 200 includes computational elements 250 performing non-linear operations, such as discrete cosine transformation, trigonometric calculations, and complex multiplications. A third type of computation unit 200 implements a finite state machine, such as computation unit 200C as illustrated in FIG. 3, particularly useful for complicated control sequences, dynamic scheduling, and input/output management, while a fourth type may implement memory and memory management, such as computation unit 200A as illustrated in FIG. 3. Lastly, a fifth type of computation unit 200 may be included to perform bit-level manipulation, such as for encryption, decryption, channel coding, Viterbi decoding, and packet and protocol processing (such as Internet Protocol processing).

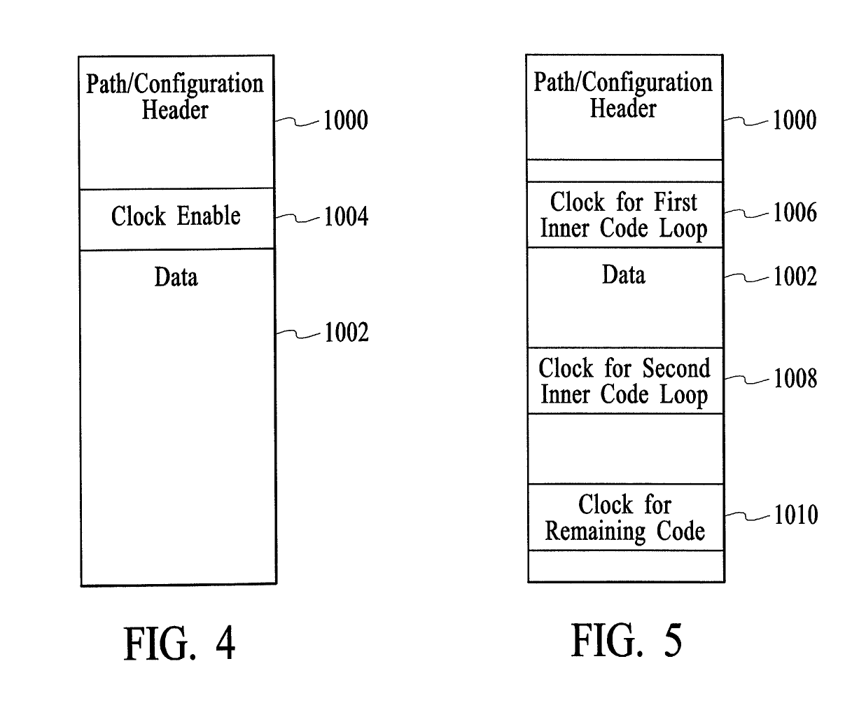

The ability to configure the elements of the ACE relies on a tight coupling (or interdigitation) of data and configuration (or other control) information, within one, effectively continuous stream of information. As illustrated in the diagram of FIG. 4, the continuous stream of data can be characterized as including a first portion 1000 that provides adaptive instructions and configuration data and a second portion 1002 that provides data to be processed. This coupling or commingling of data and configuration information, referred to as a “silverware” module, helps to enable real-time reconfigurability of the ACE 106, and in conjunction with the real-time reconfigurability of heterogeneous and fixed computational elements 250, to form different and heterogenous computation units 200 and matrices 150, enables the ACE 106 architecture to have multiple and different modes of operation. For example, when included within a hand-held device, given a corresponding silverware module, the ACE 106 may have various and different operating modes as a cellular or other mobile telephone, a music player, a pager, a personal digital assistant, and other new or existing functionalities. In addition, these operating modes may change based upon the physical location of the device; for example, when configured as a CDMA mobile telephone for use in the United States, the ACE 106 may be reconfigured as a GSM mobile telephone for use in Europe.

As an analogy, for the reconfiguration possible via the silverware modules, a particular configuration of computational elements, as the hardware to execute a corresponding algorithm, may be viewed or conceptualized as a hardware analog of “calling” a subroutine in software which may perform the same algorithm. As a consequence, once the configuration of the computational elements has occurred, as directed by the configuration information, the data for use in the algorithm is immediately available as part of the silverware module. The immediacy of the data, for use in the configured computational elements, provides a one or two clock cycle hardware analog to the multiple and separate software steps of determining a memory address and fetching stored data from the addressed registers.

In addition to the immediacy of the data, in accordance with the present invention, the silverware module is enhanced and further includes the information necessary to control the clock enable, as well as the clock tree generator of the elements configured for a particular operating mode or desired algorithm. The information is included within the data stream, preferably as clock enable portion 1004 between the first portion 1000 and second portion 1002, as illustrated in FIG. 4. In this manner, the clock enable control data that would normally require generation through dedicated and complicated control hardware or software, such as discussed with reference to the prior art, is capably and reliably provided within the data stream. With the embedding of the clock enable information as a portion in the data stream, the present invention achieves absolute clock enable control on every clocked element individually, enabling the element for the absolute minimum of time, without requiring a prohibitively expensive control structure and without complicated algorithms to predict which elements to turn on or off.

Indeed, the level of clock control can now be controlled by the programmer/designer of the silverware. Thus, in applications where low power dissipation is not an issue, a minimal amount of effort can be dedicated to clock control. In applications where the majority of power dissipation is located in a “few code loops,” a more significant amount of effort can be dedicated over the clock enables and clock generator trees for these high power burn code segments.

By way of example, suppose an application has an inner code loop that dissipates 50% of the total power required for the application and another code loop that dissipates 40% of the total power. With the ability of tailor the clock enable/clock tree generation on an individual element basis in the present invention, the silverware for the application can include separate clock enable data for each of the inner code loops requiring a majority of power dissipation and for the remaining code of the application, as represented by elements 1006, 1008, and 1010 in FIG. 5.

Such flexibility overcomes problems of current hardware designs, where the level of detail or granularity of power dissipation is fixed at design time of the ASIC or CPLDs/FPGAs, and where adding clock enables uses additional silicon area and slows down the device, as well as adding potential delay and timing race conditions.

From the foregoing, it will be observed that numerous variations and modifications may be effected without departing from the spirit and scope of the novel concept of the invention. For example, although the clock enable control information is described as a particular part of the data stream, its location within the data stream may be adjusted, if desired. Further, it is to be understood that no limitation with respect to the specific methods and apparatus illustrated herein is intended or should be inferred. It is, of course, intended to cover by the appended claims all such modifications as fall within the scope of the claims.

What is claimed is:

1. A method for reducing power consumption in an embedded system, the method comprising:
performing desired processing in the embedded system via an adaptive computing engine (ACE); and
controlling clock enabling on each individual element configured for the ACE to minimize a number of elements requiring power at any give time in the embedded system.

2. The method of claim 1 further comprising utilizing a data stream to configure the ACE to perform the desired processing.

3. The method of claim 2 further comprising embedding data for the clock enabling within the data stream.

4. The method of claim 3 wherein the data stream further comprises a first portion including adaptive instructions and configuration data and a second portion including data to be processed.

5. The method of claim 4 wherein embedding data for clock enabling within the data stream further comprises including the data for clock enabling in a portion of the data stream between the first and second portions.

6. The method of claim 2 wherein utilizing a data stream further comprises utilizing a data stream to configure the ACE as a cellular phone.

7. The method of claim 6 wherein the ACE further comprises a controller, one or more reconfigurable matrices, a matrix interconnection network, and a memory.

8. A system for controlling clock enabling in an embedded system, the system comprising:
an adaptive computing engine (ACE) to provide operational capabilities in the embedded system; and
a data stream for configuring operations in the ACE, the data stream including clock enable control information to achieve individual clocking control of each clocked element in the ACE.

9. The system of claim 8 wherein the data stream further comprises a first portion including adaptive instructions and configuration data and a second portion including data to be processed.

10. The system of claim 9 wherein the data stream further includes the clock enable control information in a portion between the first and second portions.

11. The system of claim 8 wherein the ACE further comprises a controller, one or more reconfigurable matrices, a matrix interconnection network, and a memory.

12. The system of claim 8 wherein the data stream further configures the ACE as a cellular phone.

13. A method for controlling clock enabling in an embedded system, the method comprising:
utilizing a data stream to configure an adaptive computing engine (ACE) to perform desired processing in the embedded system; and
embedding clock enable control information in the data stream to achieve individual clocking control of each clocked element in the ACE.

14. The method of claim 13 wherein the data stream further comprises a first portion including adaptive instructions and configuration data and a second portion including data to be processed.

15. The method of claim 14 wherein embedding clocking control information in a data stream further comprises including the clock enable control information in a portion of the data stream between the first and second portions.

16. The method of claim 14 wherein embedding clocking control information in a data stream further comprises including separate clock enable control information for separate code portions of an application carried by the data stream.

17. The method of claim 16 wherein including separate clock enable control information further comprises basing the separate clock enable control information according to power dissipation levels associated with the separate code portions.
